(19) United States
(12) Patent Application Publication
(10) Pub. No.: US 2005/0066273 A1
(43) Pub. Date: Mar. 24, 2005

(54) Document creation using a template

(76) Inventor: Charles Zacky, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/667,471

(22) Filed: Sep. 23, 2003

(51) Int. Cl. G06F 15/00

(52) U.S. Cl. 715/517

(57) ABSTRACT

A method of facilitating document creation using a template may include: receiving a request to create a first document according to one of a plurality of formats, each format being associated with a template; determining whether the template corresponding to the requested format is stored in a memory; and instantiating, if the template is not already stored in the memory, a template in the memory so that the template is available for future use in creating at least a second document. A related system and machine-readable medium bearing machine-readable instructions may include features similar to elements of the method.

### BACKGROUND OF THE INVENTION

Resource usage reports are used to assist administrators in determining usage characteristics of systems being monitored by the administrators. These reports may be very lengthy and may include redundant information. To ease report creation, extensible Stylesheet Language Transform (XSLT) scripts are used. XSLT scripts use XSLT which describes how a document is to be transformed using a formatting vocabulary into another document. XSLT scripts, like other script languages, are interpreted by a processor each time they are used.

The XSLT scripts map XML data into a report format specified by the XSLT script. Each of the XSLT scripts is related to a report format. In creating the reports, XML data is retrieved and applied to an XSLT script to generate a report in the format associated with the XSLT script. Scripts may be generated and loaded into memory prior to a first report request. The XSLT scripts are then available for repetitive use.

### SUMMARY OF THE INVENTION

An embodiment of the invention is directed to a method of facilitating document creation using a template. Such a method may include: receiving a request to create a first document according to one of a plurality of formats, each format being associated with a template; determining whether the template corresponding to the requested format is stored in a memory; and instantiating, if the template is not already stored in the memory, a template in the memory so that the template is available for future use in creating at least a second document.

Other aspects, advantages and novel features of the invention will become apparent from the following detailed description of the invention when considered in conjunction with the accompanying drawings.

### BRIEF DESCRIPTION OF THE DRAWINGS

FIG. 1 is an example block diagram of an application server according to an embodiment of the invention; and

FIG. 2 is an example block diagram of a report processor according to an embodiment of the invention.

FIG. 3 is an example sequence diagram of the retrieval of XSLT templates from a cache according to an embodiment of the invention;

FIG. 4 is an example sequence diagram of the creation and retrieval of an XSLT template from a cache according to an embodiment of the invention; and

FIG. 5 is an example flow chart of the creation and retrieval of an XSLT template from a cache according to an embodiment of the invention.

### DETAILED DESCRIPTION OF EMBODIMENTS

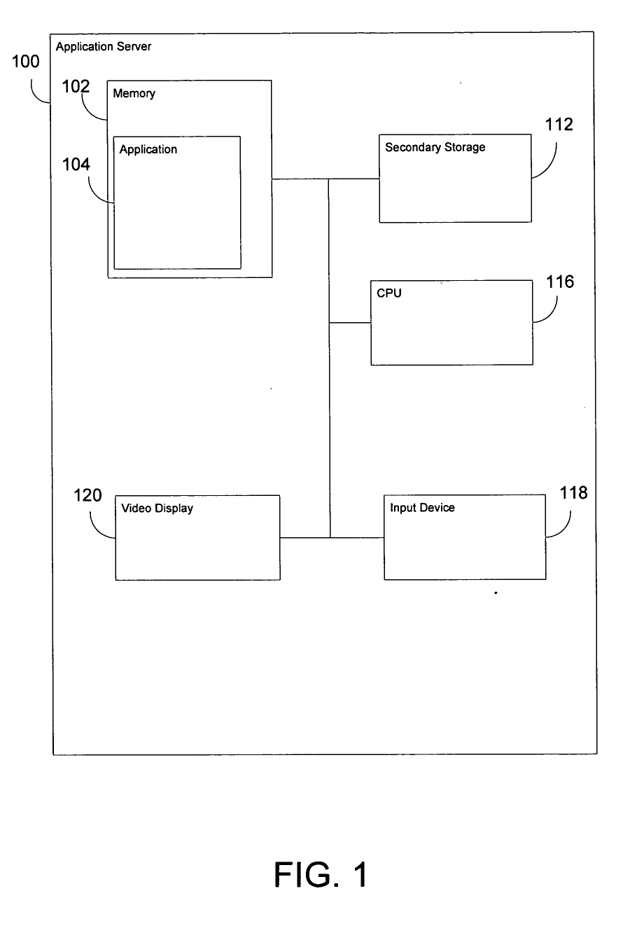

FIG. 1 is an example block diagram of an application server according to an embodiment of the invention. The application server 100 includes: a memory 102, an application 104, a secondary storage 112, a central processing unit (CPU) 116, an input device 118, and a video display 120.

The application 104 may provide services to organizations that monitor system resources. Some of the products of the application 104 may be reports provided to organizations using centralized services provided by the application 104. For example, application 104 may be a storage management application such as OpenView Storage Area Manager (OVSAM) by Hewlett-Packard Company which provides services to organizations that monitor capacity, status, performance and usage of storage.

These reports generated by the application 104 may be very lengthy and may use some of the same information. Embodiments of the invention provide a technology that allows reports to be generated to various users using a variety of formats and different content depending on the report being generated. The data files associated with each user may be similar but the viewpoint distinguishes the reports. Detailed versions and versions with a higher level of abstraction (a rollup version) of each type of report are also possible. For example, the reports may be generated in XML, HTML, or CSV using XSLT.

The application 104 may be used to create at least nine types of report formats interchangeably using 1) organization, service level, and/or storage device information content, 2) XML, HTML, or CSV formatting, and 3) detailed or rollup report types. While storage management applications may use XSLT scripts to generate reports according to a report format, an embodiment of the invention uses templates, which are compiled XSLT scripts, that are associated with a report format.

According to an embodiment of the invention, such report templates are created and stored in a memory (also referred to as being cached) when they are first needed and not before. This allows for template creation as templates are needed as opposed to creating all the templates at once which may unnecessarily utilize many data processing resources at one time. Once a template is created it may be used to create a report. The template is then made available in memory for future use in the creation of subsequent reports after the template's first such use. The use of templates also is advantageous, e.g., over the use of XSLT scripts in that a template is a compiled form of XSLT script which requires less computing resources than non-compiled XSLT scripts. Non-compiled XSLT scripts are not as efficient as templates because the non-compiled XSLT scripts require interpretation each time they are used.

As reports are needed, they may be created using the templates and data associated with an organization's usage. The creation of templates can include determining which report format is requested by a user or automated system based on content (e.g., organization, service level, or storage device) and/or format (XML, HTML, or CSV), and/or type (detailed or rollup). The detailed and rollup templates can be combined into one template. Template creation can also include taking this information and creating an XSLT script file. The script can be stored on and read from a disk. The XSLT script file is mapped into a stream source/XSL stream and is then compiled. The compiled version of the XSLT script file is a template that can be used by the application 104 to create reports. Below is described in greater detail how the templates can be created according to an embodiment of the invention.

The application server 100 may be may be a personal computer, mini-computer, or main frame computer. It is a system suitable for practicing methods and systems in a manner consistent with embodiments of the invention.

The memory 102 may be random access memory (RAM) in which an application 104 resides for processing by the CPU 116. The application 104 may be computer software that performs storage management and report processing. The secondary storage 112 may include software and data and be used for long term storage. The secondary storage 112 may be a hard drive, a mountable drive, RAID system, optical storage system, or a plurality of such storage devices to include remote storage devices. The CPU 116 is used to integrate the components of the application server 100 and the application 104 in the memory 102. The input device 118 may be a mouse, keyboard, or other input system that allows a user to interact with the application server 100. The video display 120 is a system that allows a user to receive information from the application server 100.

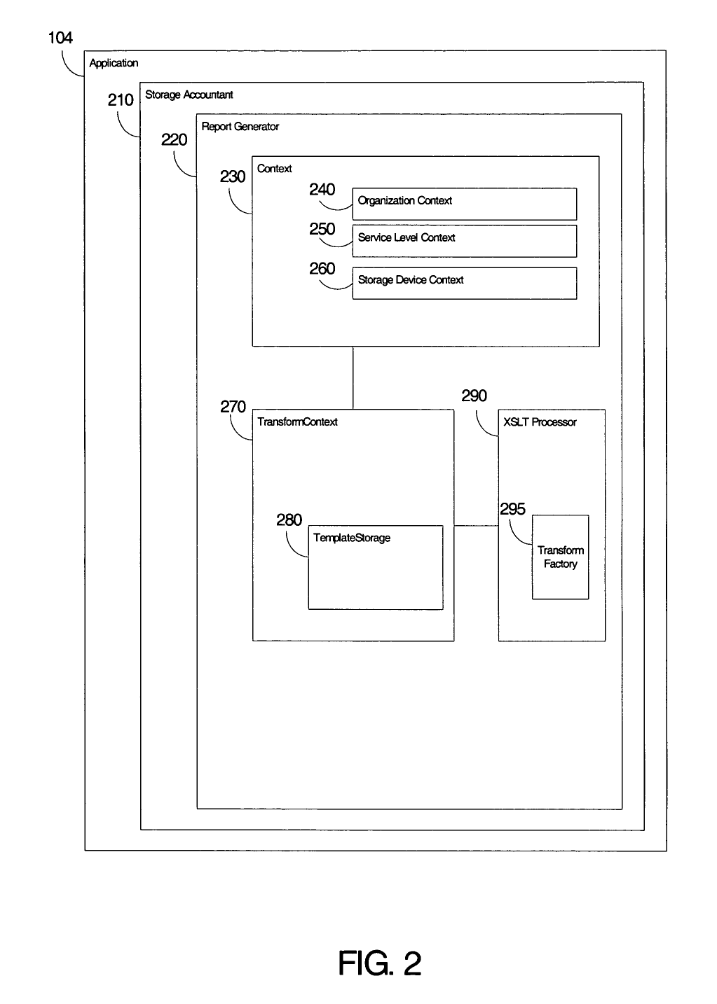

FIG. 2 is a more detailed block diagram of the application 104 according to the embodiment of FIG. 1. The application 104 may include several processes and contexts: for example, storage accountant 210, report generator 220, context 230, organization context 240, service level context 250, storage device context 260, transform context 270, template storage 280, XSLT processor 290, and transform engine (or factory) 295.

In this example, the storage accountant 210 is a usage metering process that assigns storage resources to an organization and tracks the cost of the organization's use of the storage resource. For example, if the size of storage resources associated with an organization changes, the cost may increase proportionately. Use metrics are used by the storage accountant 210 to calculate usage cost values. The storage accountant 210, additionally, allows multiple organizations to use a centralized storage. The storage accountant 210 further may meter department storage usage within an organization.

The report generator 220 is a process that receives user requests for a report. In continuing with this example, reports generated may include storage usage information related to a particular organization. The report generator 220 receives user report requests and sends the requests on to the context 230 to retrieve transform context information. The template within the transform context information is then applied to the report data. The result of the Report Generator 220 process is a formatted report.

The context 230 is a process that obtains a report output format. The context 230 receives report requests from the report generator 220, obtains an XSLT file name for the context to be used in preparing a report. The context 230 uses the filename to obtain the appropriate transform context. The context 230 further outputs the transform context to the report generator.

The organization context 240 may be a JAVA class that is a report view for organizations regarding storage use statistics. The service level context 250 may be a JAVA class that is a report view for displaying service level report information regarding storage use statistics. The storage device context 260 may be a JAVA class that is a report view for displaying storage device report information regarding storage use statistics.

The transform context 270 is a process responsible for returning transform context information including a compiled XSLT script known as a template. The transform context 270 may either obtain a template that has been compiled and stored in a template storage 280 or create a template object if one had not been created.

The template storage 280 may be allocated memory or another type of software storage media used to store templates created by the transform factory 295. The template storage 280 may include templates used in report generation. The template storage 280 may be implemented such that templates are loaded in the template storage 280 only as of when they are first called and deleted after a predetermined period of time after having last been called.

The XSLT processor 290 includes the transform factory 295. The transform factory 295 creates templates for use in report generation.

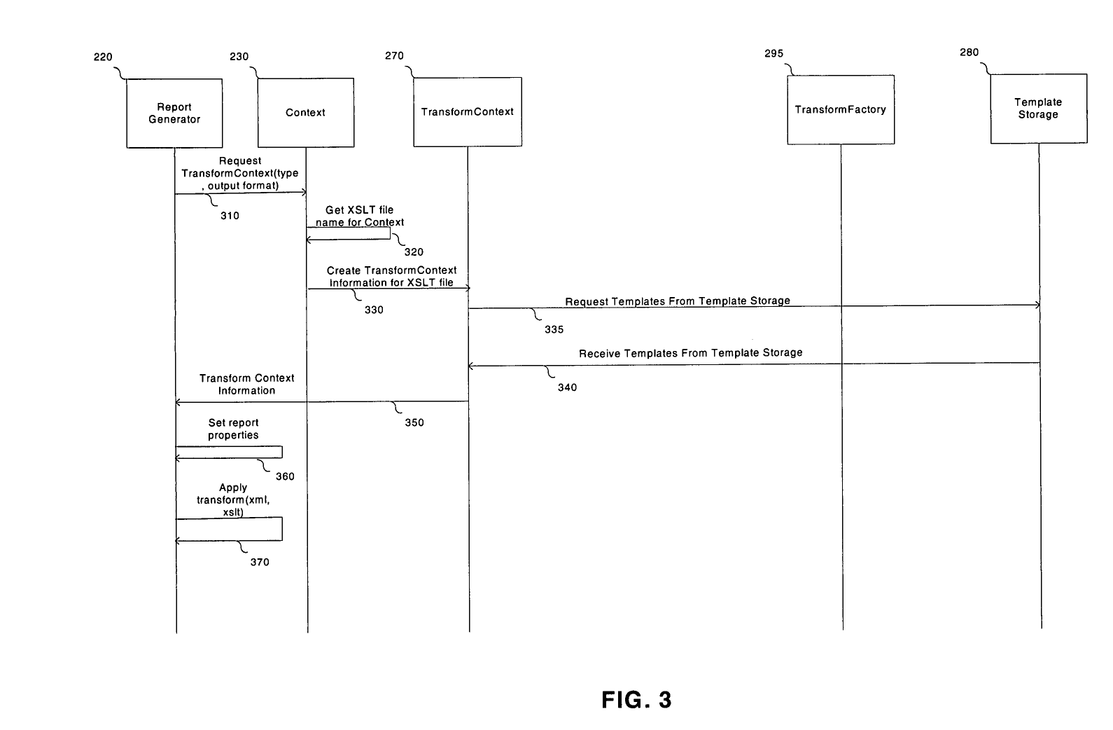

FIG. 3 is an example of a sequence-type diagram (according to the Unified Modeling Language (UML) instructions) of the retrieval of XSLT templates from a memory according to another embodiment of the invention. In UML sequence drawings. Messages are depicted with arrows of different styles. A [symbol] indicates a message that expects a response message. A [symbol] indicates a response message. A [symbol] indicates a message for which the response is implied. And a [symbol] indicates a message for which no response is expected. At arrow 310 of FIG. 3, the report generator 220 requests from the context 230 a transform context for use in report generation. At arrow 320, the context creates an XSLT file name for a context to be used in report generation. At arrow 330, the context 230 requests a transform context 270 to create transform context information for the XSLT file. The transform context 270 then requests, as indicated by arrow 335, templates from template storage 280 to be used in report generation. If the templates have been previously created, the template storage 280 returns, as indicated by arrow 340, the requested templates back to the transform context 270. When the templates for report generation have been obtained from the template storage 280 by the transform context 270, the transform context 270 provides the transform context information which includes a report template, as indicated by arrow 350, to the report generator 220. The report generator 220, upon receiving the transform context information, sets the report properties for report generation, as indicated by arrow 360, and applies the transform context information to the report, as indicated by arrow 370. The report generator 220 does so by applying the data associated with the report that may be stored in XML format to a template in XSLT format.

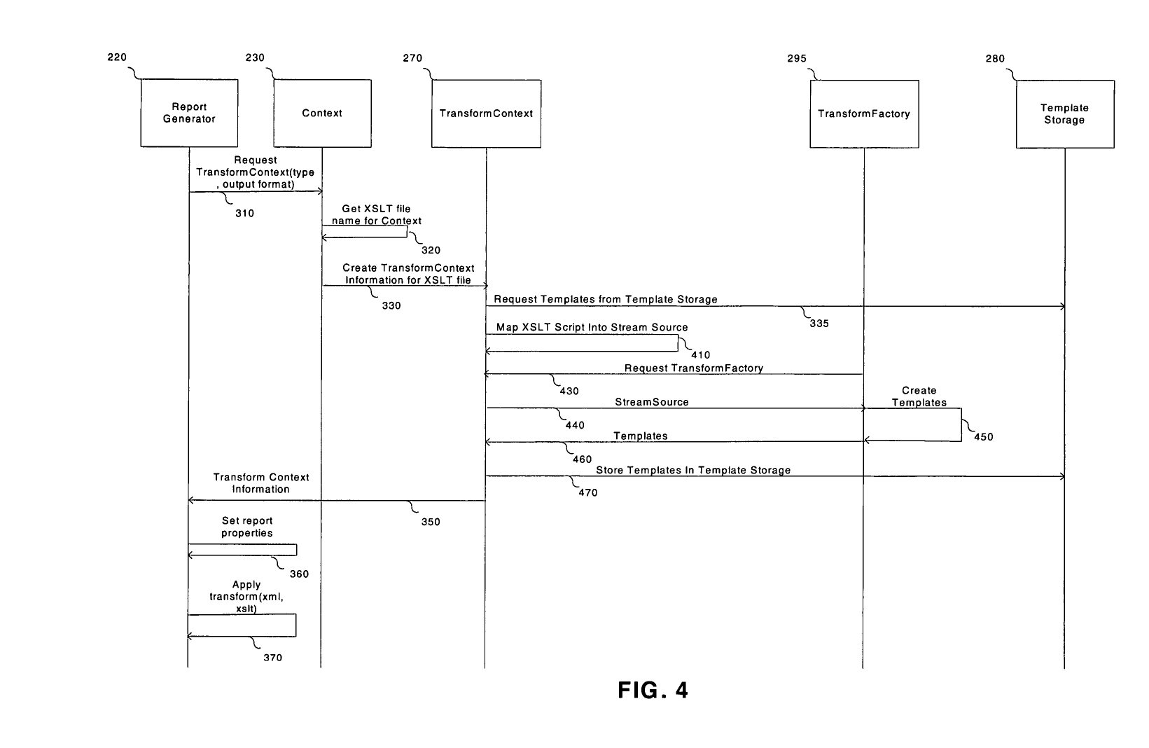

FIG. 4 is an example of a UML-type sequence diagram (according to the Unified Modeling Language) of the creation and retrieval of an XSLT template from the template storage 280 according to another embodiment of the invention. The sequence of FIG. 4 is similar to the sequence in FIG. 3, except the way it handles cases where the requested template is not in the template storage 280 as determined via the request indicated by arrow 335.

In FIG. 4, if a requested template is not in template storage 280, an XSLT script is mapped into stream source format, as indicated by arrow 410, so that it may be processed by the transform factory 295. A request is sent, as indicated by arrow 430, for a transform factory 295 object class to be created. When the transform factory 295 is created, stream source information including XSLT report information, is sent to the transform factory 295 for processing (arrow 440). When the transform factory 295 receives the stream source, it then creates the template needed for report generation (arrow 450). The template is then sent to the transform context at process 460. The transform context 270, additionally, stores (arrow 470) the template in the template storage 280. The transform context information, which includes the template, is sent to the Report Generator 220 from the transform context 270 (arrow 350). The remainder of the sequence is the same as for the sequence in FIG. 3 which ends by applying the XSLT template to XML information to generate a report of the format associated with the template.

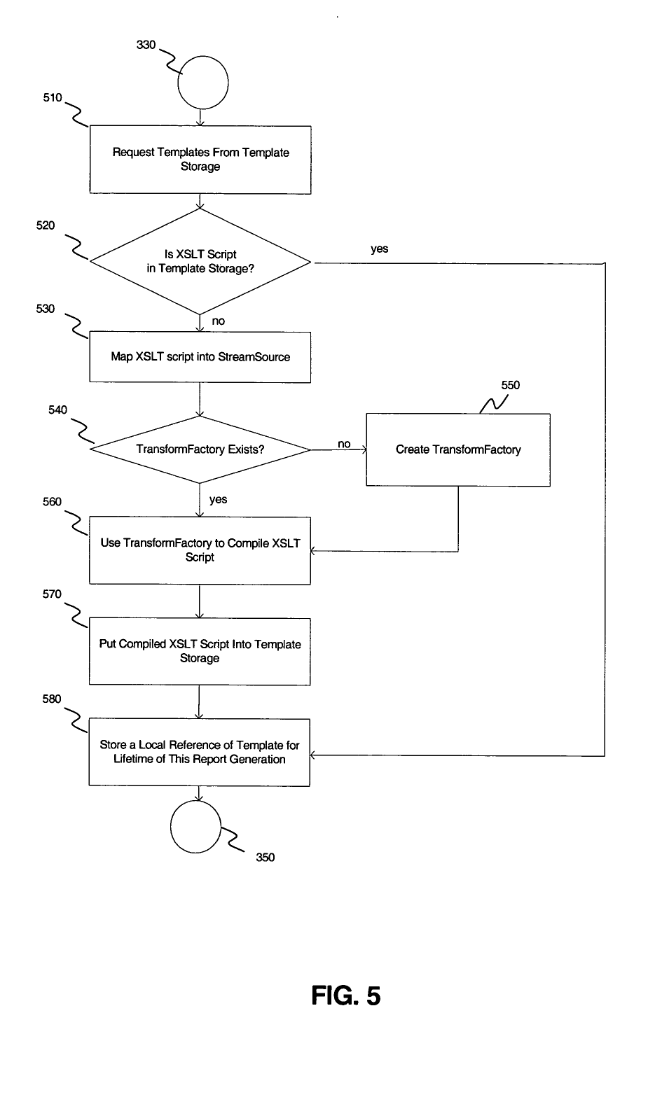

FIG. 5 is an example flow chart of the creation and retrieval of an XSLT template from a memory according to another embodiment of the invention. The flow chart of FIG. 5. corresponds to some of the logic associated with the sequence shown in FIG. 4, namely arrows 330, 410-480, and 350. At block 510, the transform context 270 requests templates from the template storage 280. The transform context 270 determines if a compiled XSLT script/template is in template storage 280 at decision block 520. If the template is in template storage 280, it is retrieved and a local reference or a pointer to the compiled script/template is stored for the lifetime of the report being generated at block 580. Flow then continues to block 360, corresponding to arrow 350 in FIG. 4.

If the template is not in template storage 280, the transform context 270 maps an XSLT script into stream source for compiling, block 530, by the transform context 270. The transform context then determines whether a transform factory object class exists for the report type being processed. If there is no transform factory 295, one is created and the process proceeds to block 560 where the transform factory 295 compiles the XSLT script to create a compiled XSLT script/template. If a transform factory 295 already exists, the XSLT script/template is likewise compiled, at block 560, by the transform factory 295 to create a template. When the template is created at block 560, the compiled XSLT script/template is placed, block 570, into template storage 280. A local reference of the compiled XSLT script/template, e.g., a pointer, is then stored for the lifetime of the current report generation. Once the report has been generated, the pointer can be removed. Alternatively, the pointer may by used when generating other reports. Moreover, the pointer may have a time to live such that if it is not used for a predetermined period of time after report generation, the pointer can be deleted from memory. Flow then proceeds to block 350, mentioned above.

Although the current embodiments described above in connection with the invention are particularly useful in reports generated describing storage usage, they may also be utilized in any other reporting system, as would be known to one of ordinary skill in the art.

It is noted that the functional blocks in the embodiments of FIGS. 1-5 may be implemented in hardware and/or software. The hardware/software implementations may include a combination of processor(s) and article(s) of manufacture. The article(s) of manufacture may further include storage media and executable computer program(s). The executable computer program(s) may include the instructions to perform the described operations. The computer executable program(s) may also be provided as part of externally supplied propagated signal(s) either with or without carrier wave(s).

This specification describes various illustrative method and system embodiments of the invention. The scope of the allowed claims is intended to cover various modifications and equivalent arrangements of the illustrative embodiments disclosed in this specification. Therefore, the allowed claims should be accorded the reasonably broadest interpretations to cover modifications, equivalent structures in features which are consistent with the spitit and the scope of the invention disclosed herein.

1. A method of facilitating document creation using a template comprising:
receiving a request to create a first document according to one of a plurality of formats, each format being associated with a template;
determining whether the template corresponding to the requested format is stored in a memory; and
instantiating, if the template is not already stored in the memory, a template in the memory so that the template is available for future use in creating at least a second document.

2. The method of claim 1, wherein the instantiating of the template in memory includes:
creating a transform factory to create the template; and
producing the template using the transform factory.

3. The method of claim 1, further comprising:
retrieving the template; and
generating at least one of the first document and the second document using the template.

4. The method of claim 1, wherein the template is a compiled XSLT script.

5. The method of claim 1, further comprising deleting at least one of the template and a pointer to the template from the memory after a predetermined amount of time.

6. The method of claim 1, wherein the memory is random access memory or cache memory.

7. A system for creating documents using a template comprising:
means for receiving a request to create a first document according to one of a plurality of formats, the format being associated with the template;
a memory;
determining means for determining whether a template corresponding to the request is stored in the memory;
means, responsive to an indication from the determining means that the template is absent from memory, for creating a transform factory to create the template;
means for producing the template using the transform factory and storing the template in the memory so that the template is available for future use in creating at least a second document; and
means for generating the first document using the template stored in the memory.

8. The system of claim 7, wherein the template is a compiled XSLT script.

9. The system of claim 7, further comprising means for deleting at least one of the template and a pointer to the template from the memory after a predetermined amount of time.

10. The system of claim 7, wherein the memory is random access memory or cache memory.

11. The system of claim 7 further including means for mapping XSLT script into an XSL stream.

12. A machine-readable medium including instructions that instruct a computer to facilitate document creation using a template, the machine-readable instructions comprising:
receiving a request to create a first document according to one of a plurality of formats, each format being associated with a template;
determining whether the template corresponding to the requested format is stored in a memory; and
instantiating, if the template is not already stored in the memory, a template in the memory so that the template is available for future use in creating at least a second document.

13. The machine-readable medium of claim 12, wherein the instructions that instruct a computer include:
creating a transform factory to create the template; and
producing the template using the transform factory.

14. The machine-readable medium of claim 12, further comprising:
retrieving the template; and
generating at least one of the first document and the second document using the template.

15. The machine-readable medium of claim 12, wherein the template is a compiled XSLT script.

16. The machine-readable medium of claim 12, wherein the memory deletes at least one of the template and a pointer to the template from the memory after a predetermined amount of time.

17. The machine-readable medium of claim 12, wherein the memory is one of random access memory and cache memory.

18. The machine-readable medium of claim 12 further including an instruction for mapping XSLT script into an XSL stream.

19. A method of document creation using a template comprising:
receiving a request to create a first document in a format of a plurality of formats, the format being associated with the template;
the method, if the template has yet to be stored in a memory, further including:
creating a transform factory to create the template;
producing the template using the transform factory;
storing the template in the memory so that the template is available for future use in creating at least a second document; and
generating the first document using the template.

20. The method of claim 19, wherein the template is a compiled XSLT script.

21. The method of claim 19 further comprising:
deleting from the memory at least one of the template and a pointer to the template after a predetermined amount of time.

22. The method of claim 19, wherein the memory is random access memory or cache memory.

23. The method of claim 19 further comprising:
means for mapping XSLT script into an XSL stream.
